(19) United States
(12) Patent Application Publication
(10) Pub. No.: US 2003/0072011 A1
(43) Pub. Date: Apr. 17, 2003

(54) Method and apparatus for combining views in three-dimensional surface profiling

(76) Inventor: Lyle G. Shirley, Boxborough, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/266,945

(22) Filed: Oct. 8, 2002

Related U.S. Application Data
(60) Provisional application No. 60/327,977, filed on Oct. 9, 2001.

(51) Int. Cl. G01B 11/24

(52) U.S. Cl. 356/601

(57) ABSTRACT

A method and apparatus for combining multiple views of an object using a three-dimensional surface profiling apparatus, which compensates for depth of field effects, is described. The apparatus utilizes a single source and a single receiver to acquire the multiple views of small objects. A lens or a system of lenses adjust the focal plane to account for the shorter distance that the radiation will travel along a first optical path than along a second optical path, so that both images are in focus on the detector at substantially the same time. For large objects, a three-dimensional surface profiling apparatus utilizing more than one camera is used.

### CROSS-REFERENCE TO RELATED APPLICATIONS

This application claims the benefits of and priority to provisional U.S. Patent Application Serial No. 60/327,977, filed on Oct. 9, 2001, and owned by the assignee of this instant application, the disclosures of which are hereby incorporated herein by reference in their entirety.

### FIELD OF THE INVENTION

The present invention relates generally to the fields of metrology and imagining technology and more specifically to devices and methods of three-dimensional surface profiling.

### BACKGROUND OF THE INVENTION

Optical systems that measure the three-dimensional shape of objects are generally limited to the surface areas of the object that can be viewed from the location of the sensor. In order to create a more complete measurement, rotating the object, moving the sensor, or combining measurements from multiple sensors having different views is necessary. Rotating the object or moving the sensor may result in higher cost through the incorporation of a positioning system, slower speeds through repetition of measurements, and loss of accuracy from registering data. Further, using multiple sensors will increase the expense of the system.

Although a mirror can be used to present an additional view to the same sensor, a three-dimensional sensor often has a finite depth of field. Light reflected from the mirror generally traverses a longer distance, which makes it difficult or impossible to monitor both views simultaneously within the depth of field of the same sensor. Measuring the top and side of a three-dimensional object using multiple mirrors illustrates a typical depth of field problem. If a mirror is used to view the side, then the distance the light travels from the side of the object to the detector is significantly larger than the distance the light travels from the top of the object to the detector. Therefore, images of the object will not be in focus on the detector at the same time.

In many three-dimensional imaging techniques, the depth of field limitation arises from using a conventional two-dimensional camera to acquire surface data. The surfaces must be within the depth of field of the imager to produce satisfactory results. The problem is compounded when small objects are imaged at high resolution—the depth of field being reduced by physical laws as the resolution improves. This effect is particularly severe for a microscopic, three-dimensional imager.

Therefore, a need exists for three-dimensional imaging techniques and instrumentation that permit the simultaneous imaging of multiple views of an object, while mitigating the problems associated with depth of field limitations.

### SUMMARY OF THE INVENTION

The present invention provides a method and apparatus for combining multiple views of an object using a three-dimensional surface profiling apparatus, which compensates for depth of field effects. In a first embodiment, the apparatus includes an optical source and two optical paths for collecting the radiation reflected from an object of interest. The first embodiment also includes a means for adjusting the focal plane to account for the different distance that the radiation travels along the first optical path than the second optical path and a detector in optical communication with the two optical paths. In another embodiment, the means for adjusting the focal plane includes a lens or system of lenses. In another embodiment, the lens is designed for extended depth of field measurements. In another embodiment, the source of the optical radiation is a laser or white light source. In yet another embodiment, optical switches are positioned to turn off either optical path and preclude the radiation from either path from reaching the detector. In another embodiment, a rotation stage is used to view more than two surfaces of the object. In yet another embodiment, a detector with adjustable focus is used to combine the multiple views.

In another aspect, the invention relates to a method for compensating for depth of field effects when illuminating two surfaces of an object with fringes. The method includes transmitting a first and second image of the two surfaces of the object along separate optical paths to the detector, while maintaining the two images in focus on the detector. In another embodiment, the method includes a step of generating the fringes. In another embodiment, the method incorporates an Accordion Fringe Interferometry three-dimensional imaging system. In yet another embodiment, the method includes transmitting the images using a fiber optic bundle. In another embodiment, the method includes the use of a lens or a system of lenses to adjust the focal plane so the two images are in focus on the detector substantially simultaneously. In another embodiment, the method includes the use of a lens designed for extended depth of field measurements. In yet another embodiment, the method includes using a camera with adjustable focus to maintain the focus of said first image and said second image.

The invention also relates to an embodiment where the radiation from the optical source is split by an optical beamsplitter. In this embodiment, a system of mirrors defines multiple optical paths, and radiation reflected from three surfaces of the object of interest is collected and transmitted to the detector. In this embodiment, a lens or system of lenses adjusts the focal plane so that all three images arrive at the detector in focus at substantially the same time. With this embodiment, three or fewer images can be focused simultaneously. In another embodiment, more than three surfaces can be focused simultaneously. In another embodiment, the source of the optical radiation is a laser or white light source. In yet another embodiment, optical switches are positioned to turn off the optical paths. Another embodiment incorporates a housing for orienting, securing, and positioning elements of the apparatus, including the optical source, the mirrors, the lens or lenses, the optical switches, and the detector.

For microscopic objects, the embodiment including a system of mirrors to collect reflected radiation from the object of interest and a system of lenses to adjust the focal planes is the most appropriate solution to compensate for the depth of field limitation. For larger objects on the order of meters, using a system of mirrors to reflect radiation to a single detector may not be feasible. Either the size of the mirrors required or the necessary position or angle of the mirrors needed to navigate the beam of radiation around the object and to the detector may not be practical.

In another aspect, the invention relates to a method and apparatus for combining multiple views of an object using a three-dimensional surface profiling apparatus, which incorporates more than one camera. In another embodiment of the invention, the apparatus includes an optical source and two optical paths for collecting the radiation reflected from an object of interest. This embodiment includes a first detector in optical communication with the first optical path, and a second detector in optical communication with the second optical path.

In another aspect, the invention relates to a method for compensating for depth of field effects when illuminating two surfaces of an object with fringes by using more than one detector. The method includes transmitting a first image of the first surface of the object illuminated by the fringes to a first detector and transmitting a second image of the second surface of the object illuminated by the fringes to a second detector, while maintaining the two images in focus on their respective detectors at substantially the same time. In another embodiment, the method includes a step of generating the fringes. In another embodiment, the first image is transmitted to the second detector, with a fixed offset between the first and second detector.

Other aspects and advantages of the present invention will become apparent from the following drawings, detailed description, and claims, all of which illustrate the principles of the invention, by way of example only.

### BRIEF DESCRIPTION OF THE DRAWINGS

The foregoing and other objects, features, and advantages of the invention described above will be more fully understood from the following description of various embodiments, when read together with the accompanying drawings. In the drawings, like reference characters generally refer to the same parts throughout the different views. The drawings are not necessarily to scale, and emphasis instead is generally placed upon illustrating the principles of the invention.

FIG. 1 is a schematic of an embodiment of the invention that illustrates various optical paths of a three-dimensional surface profiling apparatus that utilizes a single detector and is constructed in accordance with the invention;

FIG. 2 is a schematic of another embodiment of the invention that illustrates various optical paths of a three-dimensional surface profiling apparatus that utilizes a single detector and is constructed in accordance with the invention;

FIG. 3 is a schematic of another embodiment of a three-dimensional surface profiling apparatus that utilizes a single detector and is constructed in accordance with the invention;

FIG. 4 is a schematic of another embodiment of the invention that illustrates various optical paths of a three-dimensional surface profiling apparatus that utilizes more than one detector and is constructed in accordance with the invention; and

FIG. 5 is a schematic block diagram of various components of an Accordion Fringe Interferometry system suitable for use with the various embodiments of the invention.

### DESCRIPTION OF THE PREFERRED EMBODIMENTS

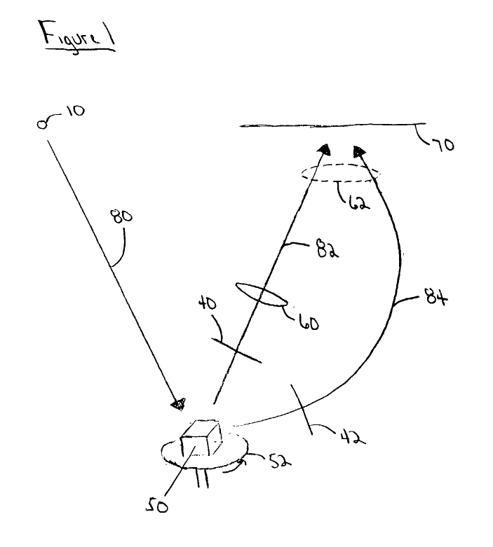

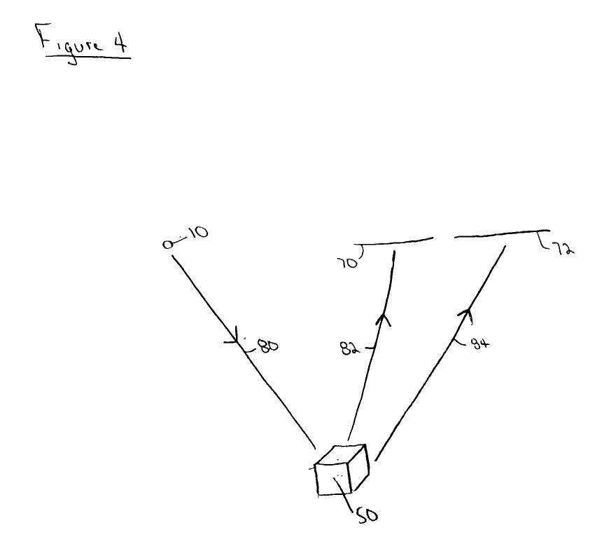

FIGS. 1, 2, and 3 illustrate embodiments of an apparatus for combining the views of a plurality of surfaces of an object in a three-dimensional surface profiling system, which compensates for depth of field effects. The apparatus utilizes a single source and a single receiver to acquire the multiple views of the object of interest. FIG. 4 illustrates an embodiment of an apparatus that utilizes more than one detector for combining the views of a plurality of surfaces of an object in a three-dimensional surface profiling system.

FIG. 1 illustrates one embodiment of the invention. In this embodiment, the apparatus includes an optical source 10, an optical path 80 for transmitting source radiation to the object of interest 50, two optical paths 82 and 84 for collecting reflected radiation from an object of interest 50, a means for adjusting the focal plane to account for the different distance that the radiation travels in optical path 82 than optical path 84, and a detector 70. Optical switches 40 and 42 are positioned to turn off either optical path, thus precluding the radiation from reaching the detector 70. A rotation stage 52 also can be employed to view more than two surfaces of the object 50.

In FIG. 1, radiation from the optical source 10 is incident on the object of interest 50 along an optical path 80. Images formed by the radiation reflected from the two surfaces of the object 50 are transmitted along two optical paths 82 and 84 and received by the detector 70. In one embodiment, a lens 60 is placed in the first optical path 82. This lens 60 adjusts the focal plane of the first optical path 82 to account for the different distance that the radiation travels along the first optical path 82 than the second optical path 84, so that both images are in focus on the detector 70 at substantially the same time. In one embodiment, the lens 60 is designed for extended depth of field measurements by trading-off the sharpness of the best focus for depth of field. The optical source 10 can be a laser or white light source capable of generating interference fringes. The optical switches 40 or 42 in various embodiments are mechanical choppers or acousto-optic modulators. In one embodiment, an optical fiber bundle is either the first 82 or the second 84 optical path. The detector 70 is typically a CCD.

In another embodiment of FIG. 1, a collection scheme with a system of lenses 60 and 62 is used to compensate for depth of field. In yet another embodiment, a single camera with adjustable focus is used to compensate for depth of field. For example, the system can be calibrated for a sequence of focal positions and the data combined to extend the depth of field. The focus mechanism can have discrete and repeatable stops, an encoder that measures the focal position, or a feedback loop that sets the focal position at known values. If the focal stops are not discrete, but are measured, the changes to the calibration parameters can be determined as a function of focal position and applied.

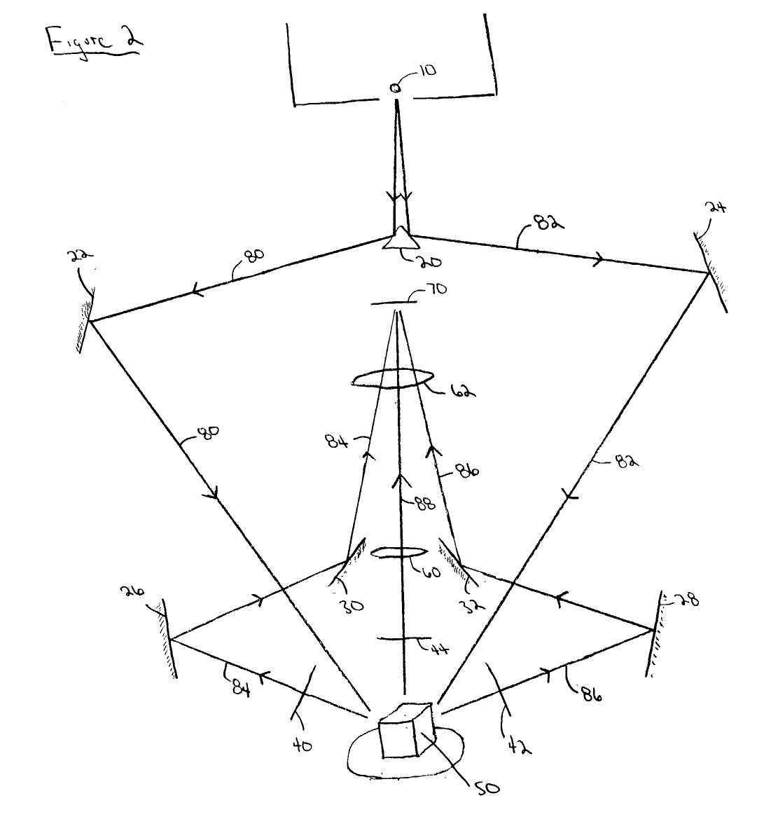

FIG. 2 illustrates another embodiment constructed in accordance with the invention. The embodiment of FIG. 1 permits two surfaces of the object of interest 50 to be viewed simultaneously. The embodiment of FIG. 2 allows three surfaces of the object of interest to be viewed simultaneously. In this embodiment, a beamsplitter 20 splits the radiation emitted by the optical source 10. A first beam 80 from the beamsplitter is directed to the object of interest 50 by a first mirror 22. An image 84 formed by radiation reflected from the first surface of the object 50 is directed to a second mirror 26, which transmits the radiation to a third mirror 30. The third mirror 30 directs the image 84 to the detector 70 through a first lens 62.

In the embodiment illustrated in FIG. 2, the second beam 82 from the beamsplitter 20 is directed to the object of interest 50 by a fourth mirror 24. An image 86 formed by radiation reflected from the second surface of the object 50 is directed to a fifth mirror 28, which transmits the radiation to a sixth mirror 32. The sixth mirror 32 directs the image 86 to the detector 70 through the first lens 62. An image 88 formed by radiation reflected from a third surface of the object 50 is focused on the detector 70 using a second lens 60 and the first lens 62. The second lens 60 adjusts the focal plane of the third optical path 88 to account for the different distance that the radiation travels along the third optical path 88 than the first 84 and second 86 optical paths. Therefore, all three images are in focus on the detector 70 at substantially the same time.

In one embodiment, the beamsplitter 20 includes two mirrors at opposing 45° angles. In other embodiments, the angles of the two mirrors may be greater or less than 45°. In another embodiment, the beamsplitter 20 is a pellicle beamsplitter or a cube beamsplitter. Like the first embodiment, the optical source 10 is a laser or white light source capable of generating interference fringes. In this embodiment, the optical switches 40, 42 or 44 are mechanical choppers or acousto-optic modulators, and any optical path can include an optical fiber bundle.

A third embodiment of the invention incorporates a housing 90, which secures, orients, and positions individual elements of the apparatus. In this embodiment, a beamsplitter 20 splits the radiation emitted by the optical source 10. A first beam 80 from the beamsplitter is directed to the object of interest 50 by a first mirror 22. An image 84 formed by radiation reflected from the first surface of the object 50 is directed to a second mirror 26, which transmits the radiation to a third mirror 30. The third mirror 30 directs the image 84 to the detector 70 through a first lens 62.

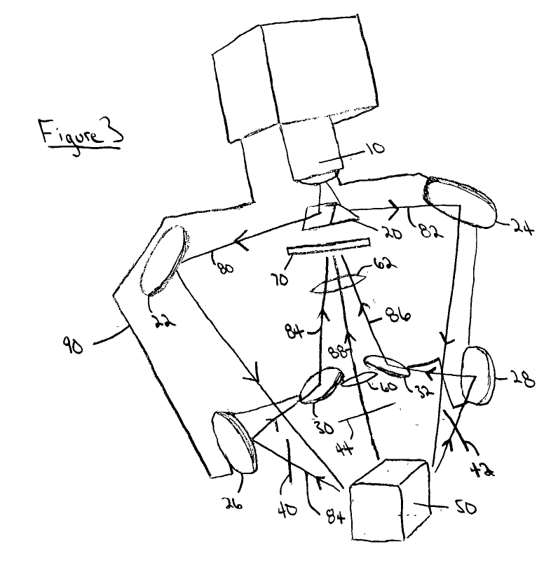

In the embodiment illustrated in FIG. 3, the second beam 82 from the beamsplitter 20 is directed to the object of interest 50 by a fourth mirror 24. An image 86 formed by radiation reflected from the second surface of the object 50 is directed to a fifth mirror 28, which transmits the radiation to a sixth mirror 32. The sixth mirror 32 directs the image 86 to the detector 70 through the first lens 62. An image 88 formed by radiation reflected from a third surface of the object 50 is focused on the detector 70 using a second lens 60 and the first lens 62. The second lens 60 adjusts the focal plane of the third optical path 88 to account for the different distance that the radiation travels along the third optical path 88 than the first 84 and second 86 optical paths. Therefore, all three images are in focus on the detector 70 at substantially the same time.

In the third embodiment, the beamsplitter 20 includes two mirrors at opposing 45° angles, and the optical source 10 is a light source capable of generating interference fringes. In other embodiments, the angles of the two mirrors may be greater or less than 45°. In this embodiment, the optical switches 40, 42 or 44 are mechanical choppers.

FIG. 4 illustrates another embodiment of the invention, where more than one detector is used to compensate for depth of field. In this embodiment, the apparatus includes an optical source 10, an optical path 80 for transmitting source radiation to the object of interest 50, two optical paths 82 and 84 for collecting reflected radiation from the object of interest 50, and two detectors 70 and 72. In one embodiment, the two detectors 70 and 72 are focused on different surface areas to combine different views. In another embodiment, the two detectors 70 and 72 are focused at different overlapping ranges of the same surface to extend the total depth of field. The two detectors 70 and 72 have slight offsets and cover approximately the same lateral area to simply extend the depth of field. For larger objects, using a system with more than one detector may not be more expensive than using the embodiment in FIG. 1. The cost of additional detectors may be less than the cost of the mirrors or positioning system required for the larger objects. In addition, the exposure time of each camera can be adjusted independently depending on the return level for optimal dynamic range.

In a preferred embodiment, the optical systems described in FIGS. 1, 2, 3 and 4 are used in conjunction with an Accordion Fringe Interferometry (AFI) three-dimensional imaging system as described in U.S. Pat. Nos. 5,870,191 and 6,031,612, the disclosures of which are herein incorporated by reference. AFI utilizes an interference fringe pattern, which is achieved by splitting a laser beam into two point sources, to illuminate an object of interest. The fringes generated are always in focus on the object since they are produced by interference and have unlimited depth of field.

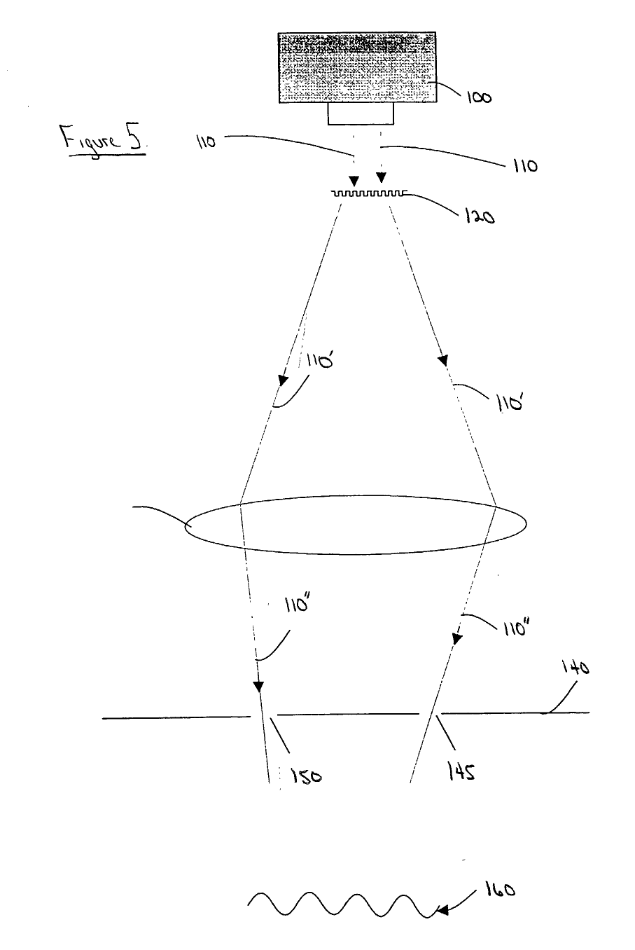

Referring to FIG. 5, an AFI system suitable for use with the invention is illustrated. This fringe projection based system, includes an expanded collimated laser source 100 which emits a beam 110 that passes through a binary phase grating 120 in various embodiments. The light 110′ diffracted from the phase grating 120 is focused by an objective lens 130 on to a spatial filter 140. All of the various diffraction orders from the phase grating 120 are focused into small spots at the plane of the spatial filter 140. The spatial filter in one embodiment is a thin stainless steel disk that has two small holes 145 and 150 placed at the locations where the +/−1^{st} diffraction orders are focused. The light 110″ in the +/−1^{st} diffraction orders is transmitted through the holes 145 and 150 in the spatial filter 140, while all other orders are blocked. The +/−1^{st} order light passing through the two holes forms the two ‘point sources’ required for the AFI system. The light 110″ expands from the two point sources and overlaps, forming interference fringes 160 having sinusoidal spatial intensity.

A CCD camera is positioned at a known angle from the laser source to capture images of the object, which is swathed by the interference fringes. Depending on the contour of the object, the fringes are seen as curved from the camera's point of view. The degree of apparent curvature, coupled with the known angle between the camera and laser source, enable the AFI algorithm to triangulate the surface topology of the object being imaged.

The triangulation process is iterative and begins with a coarse set of fringes projected on the surface. The phase of this fringe pattern is shifted in discrete increments, and the CCD acquires an image at each shift. The multiple images are reduced to a phase map. This process is repeated with progressively finer fringes. The resulting phase maps are used to create a final phase map that is then converted into a dense, x,y,z point cloud, which accurately represents the real world to micron-level precision. In this manner, the top and sides of the object are viewed with a single source and receiver, while optimizing the focus for each side of the object.

The AFI algorithm is general-purpose, which allows digitization of objects of arbitrary size and arbitrary complexity, at any scale. For example, the object may be a face, a tooth, a small-machined part such as a screw, a turbine blade, or various larger parts. Since depth of field becomes more and more critical as the resolution improves, the greatest advantage is achieved at the microscopic scale.

What is claimed is:

1. An apparatus for compensating for depth of field effects when measuring an object having a first object surface and a second object surface, the apparatus comprising:
an optical source;
a first optical path in optical communication with said optical source;
a second optical path in optical communication with said optical source; and
a detector in optical communication with said first and said second optical paths,
wherein a first image from said first object surface directed to said detector by said first optical path and a second image from said second object surface directed to said detector by said second optical path are in focus at substantially the same time.

2. The apparatus of claim 1, wherein said first optical path comprises a first lens.

3. The apparatus of claim 2, wherein said first lens is designed for extended depth of field measurements.

4. The apparatus of claim 2, wherein said first optical path comprises a second lens.

5. The apparatus of claim 2, wherein said second optical path comprises said first lens.

6. The apparatus of claim 1, wherein said detector is a camera with adjustable focus.

7. The apparatus of claim 1, wherein the means for producing optical radiation is a laser.

8. The apparatus of claim 1, wherein the means for producing said optical radiation is a white light source.

9. The apparatus of claim 1, wherein said first optical path comprises a first optical switch.

10. The apparatus of claim 1, wherein said second optical path comprises a second optical switch.

11. The apparatus of claim 9, wherein said first optical switch is a first mechanical chopper.

12. The apparatus of claim 10, wherein said second optical switch is a second mechanical chopper.

13. The apparatus of claim 9, wherein said first optical switch is a first acousto-optic modulator.

14. The apparatus of claim 10, wherein said second optical switch is a second acousto-optic modulator.

15. A method for compensating for depth of field effects comprising the steps of:
illuminating two surfaces of an object with fringes;
transmitting a first image of a first surface of said object illuminated by said fringes to a detector using a first optical path;
transmitting a second image of a second surface of said object illuminated by said fringes to said detector using a second optical path; and
maintaining said first image and said second image of said object in focus on said detector substantially simultaneously.

16. The method of claim 15 further comprising a step of generating said fringes.

17. The method of claim 15, wherein the step of transmitting said first image comprises transmitting said first image using an optical fiber bundle.

18. The method of claim 15, wherein the step of transmitting said second image comprises transmitting said second image using an optical fiber bundle.

19. The method of claim 15, wherein the focus of said first object is maintained by a first lens.

20. The method of claim 15, wherein the focus of said second object is maintained by said first lens.

21. The method of claim 19, wherein the focus of said first object is maintained by a second lens.

22. The method of claim 15, wherein the focus of said first image and said second image is maintained by a camera with adjustable focus.

23. An apparatus for compensating for depth of field effects when measuring an object having a first object surface, a second object surface, and a third object surface, the apparatus comprising:
an optical source;
a beam splitter in optical communication with said optical source;
a first mirror in optical communication with said beam splitter, wherein said first mirror is in optical communication with said first object surface;
a second mirror in optical communication with said first object surface,
a first lens;
a third mirror in optical communication with said second mirror, wherein said third mirror is in optical communication with said first lens;
a fourth mirror in optical communication with said beam splitter, wherein said fourth mirror is in optical communication with said second object surface;
a fifth mirror in optical communication with said second object surface,
a sixth mirror in optical communication with said fifth mirror, wherein said sixth mirror is in optical communication with said first lens;
a second lens in optical communication with said third object surface, wherein said second lens is in optical communication with said first lens;
a detector in optical communication with said first lens, wherein a first image from said first object surface directed to said detector, and a second image from said second object surface directed to said detector, and a third image from said third object surface directed to said detector are in focus at substantially the same time.

24. An apparatus for compensating for depth of field effects when measuring an object having a first object surface and a second object surface, the apparatus comprising:
an optical source;
a first optical path in optical communication with said optical source;
a second optical path in optical communication with said optical source;
a first detector in optical communication with said first optical path; and
a second detector in optical communication with said second optical path;
wherein a first image from said first object surface directed to said first detector by said first optical path and a second image from said second object surface directed to said second detector by said second optical path are in focus at substantially the same time on their respective detectors.

25. A method for compensating for depth of field effects comprising the steps of:
illuminating two surfaces of an object with fringes;
transmitting a first image of a first surface of said object illuminated by said fringes to a first detector using a first optical path;
transmitting a second image of a second surface of said object illuminated by said fringes to said second detector using a second optical path; and
maintaining said first image on said first detector and said second image on said second detector in focus at substantially the same time.

26. The method of claim 25 further comprising a step of generating said fringes.

27. The method of claim 25, wherein said first image of the first object surface of said object illuminated by said fringes is transmitted to said second detector
